(19) United States
(12) Patent Application Publication
(10) Pub. No.: US 2026/0137572 A1
(43) Pub. Date: May 21, 2026

(54) CUSHIONING APPARATUS FOR PREVENTING BED SORE DEVELOPMENT

(71) Applicant: Peter Nicolazzi, Saint Louis, MO (US)

(72) Inventor: Peter Nicolazzi, Saint Louis, MO (US)

(21) Appl. No.: 18/953,290

(22) Filed: Nov. 20, 2024

(51) Int. Cl. A61G 7/057

(52) U.S. Cl. CPC A61G 7/05769

(57) ABSTRACT

A cushioning apparatus for prevent development of bed sores on a user's body includes a wrap with a first layer and a second layer coupled together. The first layer is coextensive with the second layer, and the wrap has a casing portion in which the first layer and the second layer surround an interior space. The first and second layers comprise a flexible fabric material wherein the wrap may be curved into a use position to surround a portion of the body of the user. A support member is coupled to the wrap and is positioned in the interior space of the casing portion. The support member comprises a plurality of enclosed capsules, each of which surrounds a volume of gas.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to cushion apparatuses and more particularly pertains to a new cushion apparatus for cushioning a portion of a user's body to prevent development of bed sores on that portion.

### (2) Description of Related Art Including Information Disclosed Under 37 CFR 1.97 and 1.98

The prior art relates to cushion apparatuses which rely on gas-filled cells to support at least a part of a user's body. The prior art includes apparatuses in which apertures facilitate drainage of fluid, which might be absorbed by an absorbent material positioned below the gas-filled cells. However, the prior art fails to describe such an apparatus which surrounds the gas-filled cells in a flexible and absorbent wrap such that the wrap may lie against the user's skin and absorb fluids immediately rather than facilitating drainage.

### (h) BRIEF SUMMARY OF THE INVENTION

An embodiment of the disclosure meets the needs presented above by generally comprising a wrap with a first layer and a second layer coupled together. The first layer is coextensive with the second layer, and the wrap has a casing portion in which the first layer and the second layer surround an interior space. The first and second layers comprise a flexible fabric material wherein the wrap may be curved into a use position to surround a portion of the body of the user. A support member is coupled to the wrap and is positioned in the interior space of the casing portion. The support member comprises a plurality of enclosed capsules, each of which surrounds a volume of gas.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a cushioning apparatus according to an embodiment of the disclosure.

FIG. 2 is a front view of an embodiment of the disclosure.

FIG. 3 is a back view of an embodiment of the disclosure.

FIG. 4 is a cross-sectional view of an embodiment of the disclosure taken from Line 4-4 in FIG. 2.

FIG. 5 is an in-use view of an embodiment of the disclosure.

### (j) DETAILED DESCRIPTION OF THE INVENTION

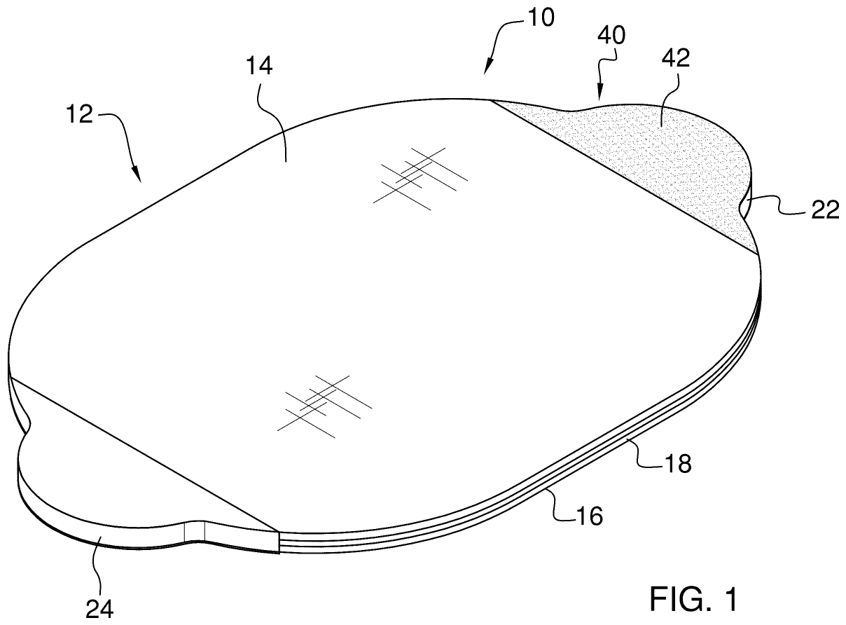

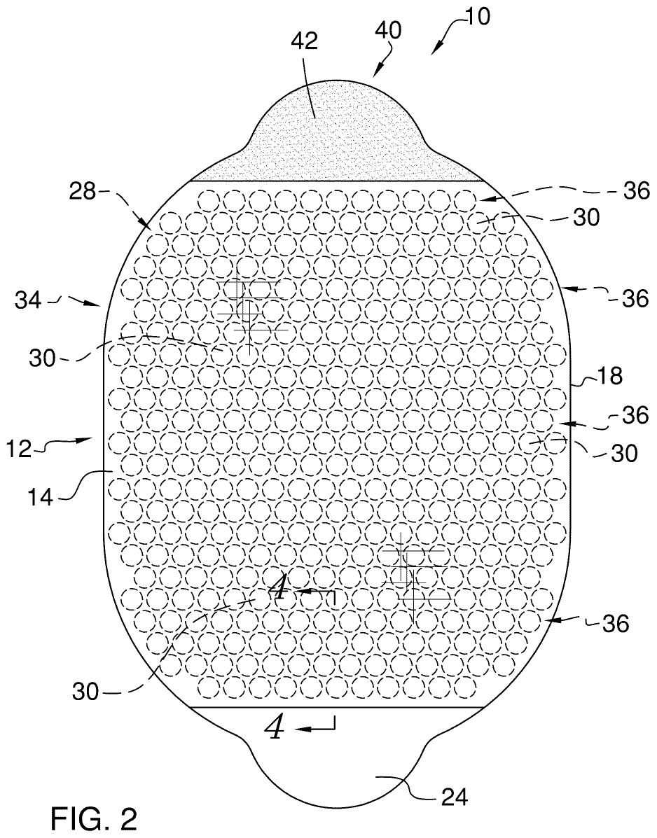

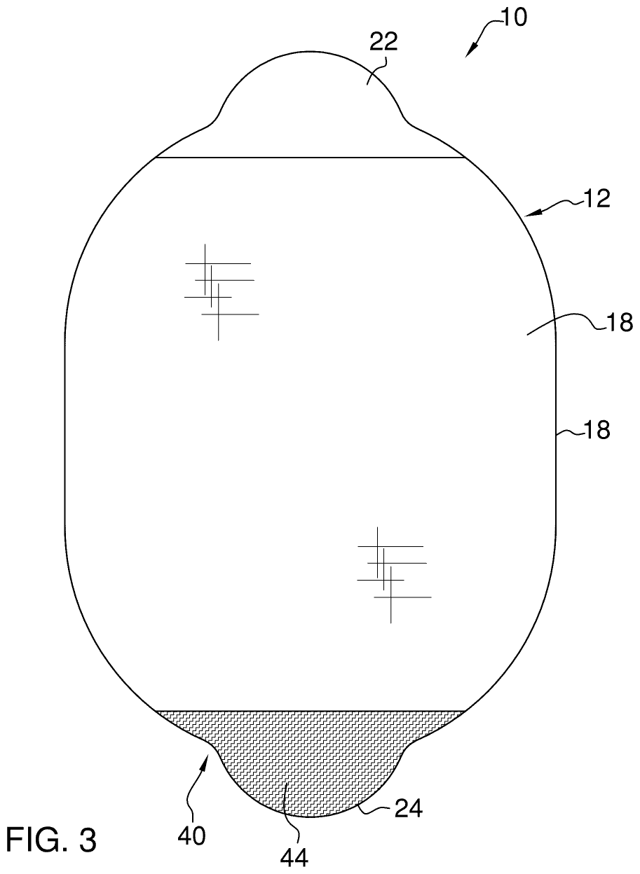

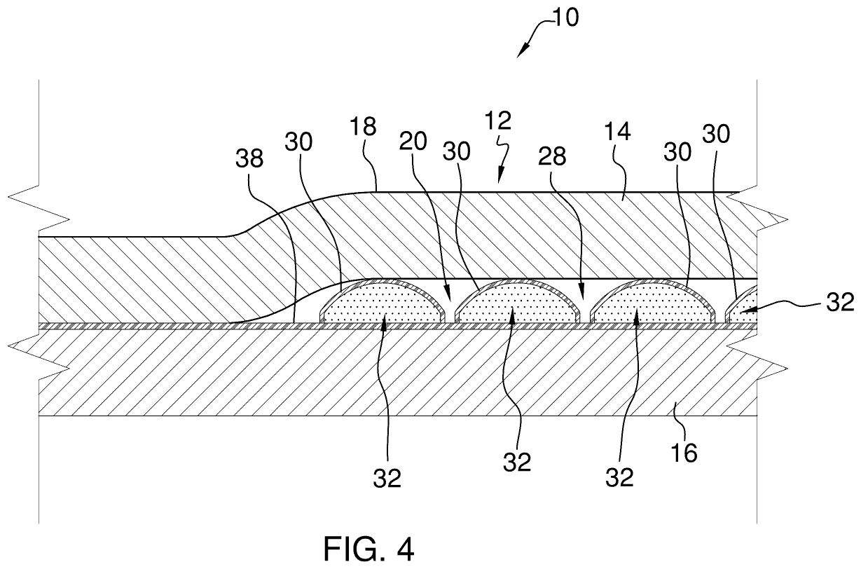

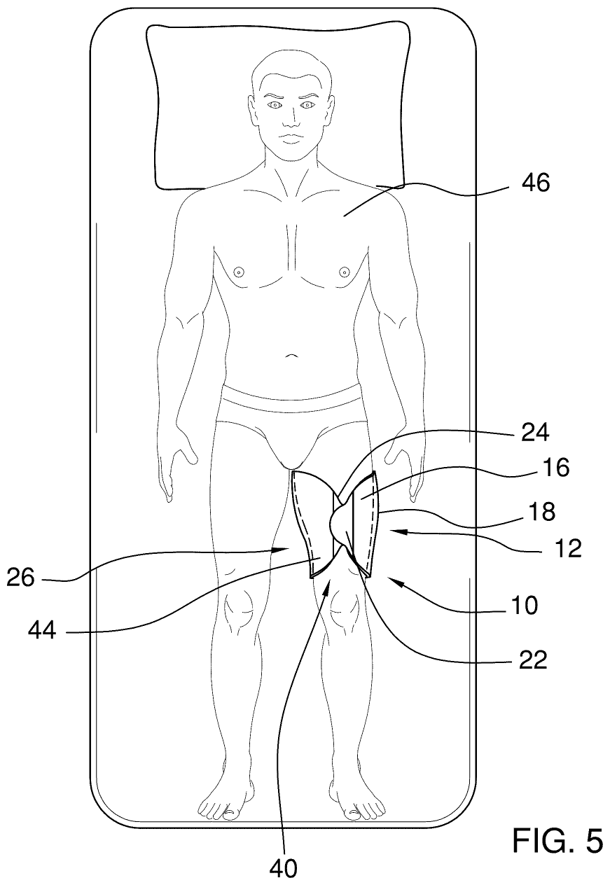

With reference now to the drawings, and in particular to FIGS. 1 through 5 thereof, a new cushion apparatus embodying the principles and concepts of an embodiment of the disclosure and generally designated by the reference numeral 10 will be described.

As best illustrated in FIGS. 1 through 5, the cushioning apparatus 10 generally comprises a wrap 12 which comprises a first layer 14 and a second layer 16 coupled together. The first layer 14 is coextensive with the second layer 16. The wrap 12 has a casing portion 18 in which the first layer 14 and the second layer 16 surround an interior space 20. The wrap 12 also has a first tab portion 22 and a second tab portion 24 positioned opposite each other across the casing portion 18 in which the first layer 14 is coupled to the second layer 16. The first and second layers 14, 16 comprise a flexible fabric material wherein the wrap 12 may be curved into a use position 26 to surround a portion of the body of a user 46. The flexible fabric material is absorbent such that the flexible fabric material is configured to absorb body fluid of the user 46. The flexible fabric material may be, for example, a polypropylene or a bio-polypropylene, which is a polypropylene in which the polymers used for the material are derived from biological sources. The flexible fabric material may comprise any suitable material for curving into the use position 26 and absorbing bodily fluid and may have properties for wicking the bodily fluids away from the body. For example, the flexible fabric material may comprise polyester, nylon, wool, or the like.

A support member 28 is coupled to the wrap 12 and is positioned in the interior space 20 of the casing portion 18. The support member 28 comprises a plurality of enclosed capsules 30, each of which surrounds a volume of gas 32. The volumes of gas 32 of the plurality of capsules are separated from each other. The gas may be air, nitrogen, an inert gas, or any suitable gas for maintaining the enclosed capsules 30 in an at least partially inflated state. The enclosed capsules 30 may comprise a plastic or similarly flexible material such that the enclosed capsules 30 conform to a surface which the wrap 12 is pressed against. The plurality of enclosed capsules 30 is arranged in an array 34 comprising a plurality of rows 36 of enclosed capsules 30. The rows 36 are aligned parallel to each other, and the enclosed capsules 30 of adjacent rows 36 of the plurality of rows 36 are offset from each other along their respective rows 36. The support member 28 has a base layer 38 upon which the enclosed capsules 30 are mounted. The base layer 38 is sandwiched between the first and second layers 14, 16 of the wrap 12 in the first tab portion 22 and the second tab portion 24. The first and second layers 14, 16 of the wrap 12 may be coupled to the base layer 38 of the support member 28 via adhesives, thread, or the like.

A connector 40 is coupled to the wrap 12. The connector 40 has a first mating member 42 positioned on an exterior of the first layer 14 on the first tab portion 22 of the wrap 12 and a second mating member 44 positioned on an exterior of the second layer 16 on the second tab portion 24 of the wrap 12. The first mating member 42 is releasably couplable to the second mating member 44 to secure the wrap 12 in the use position 26. The connector 40 comprises a hook-and-loop fastener but may comprise a strap (such as an adjustable-length strap), a snap button fastener, a magnetic fastener, or the like.

In use, the wrap 12 is positioned in the use position 26 around the portion of the body of the user 46, which may be an arm, a leg, a torso, or any other portion around which the wrap 12 may be placed. The connector 40 is fastened such that the wrap 12 is secured in the use position 26. While in the use position 26, the support member 28 cushions the portion of the body, distributing pressure such that bed sores are less likely to develop. The flexible fabric material absorbs and may wick bodily fluids from the user 46 such as sweat such that the portion of the body is kept dry, which further decreases the likelihood that bed sores develop.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cushioning apparatus for preventing sores from developing on a body of a user, the cushioning apparatus comprising:
a wrap comprising a first layer and a second layer coupled together, the first layer being coextensive with the second layer, the wrap having a casing portion in which the first layer and the second layer surround an interior space, the first and second layers comprising a flexible fabric material wherein the wrap is configured to be curved into a use position to surround a portion of the body of the user where a bed sore is located, each of the first layer and the second layer having a continuous planar exterior surface wherein one of the first layer and the second layer is configured to be in direct physical contact with the portion of the body of the user where the bed sore is located; and
a support member coupled to the wrap and positioned in the interior space of the casing portion, the support member comprising a plurality of enclosed capsules, each enclosed capsule of the plurality of enclosed capsules surrounding a volume of gas.

2. The cushioning apparatus of claim 1, wherein the flexible fabric material is absorbent such that the flexible fabric material is configured to absorb body fluid of the user.

3. The cushioning apparatus of claim 2, wherein the flexible fabric material comprises polypropylene.

4. The cushioning apparatus of claim 1, further comprising a connector coupled to the wrap, the connector having a first mating member and a second mating member positioned opposite each other across the casing portion, the first mating member being releasably couplable to the second mating member to secure the wrap in the use position.

5. The cushioning apparatus of claim 4, wherein:
the wrap has a first tab portion and a second tab portion positioned opposite each other across the casing portion, the first layer being coupled to the second layer in the first tab portion and the second tab portion of the wrap; and
the first mating member of the connector is positioned on the first tab portion of the wrap, the second mating member of the connector being positioned on the second tab portion of the wrap.

6. The cushioning apparatus of claim 5, wherein the first mating member of the connector is positioned on the continuous planar exterior surface of the first layer of the wrap, the second mating member of the connector being positioned on the continuous planar exterior surface of the second layer of the wrap.

7. The cushioning apparatus of claim 1, wherein the volumes of gas of the plurality of capsules are separated from each other.

8. The cushioning apparatus of claim 1, wherein the plurality of enclosed capsules is arranged in an array, the array comprising a plurality of rows of enclosed capsules, the plurality of rows being aligned parallel to each other, the enclosed capsules of adjacent rows of the plurality of rows being offset from each other along their respective rows.

9. A cushioning apparatus for preventing sores from developing on a body of a user, the cushioning apparatus comprising:
a wrap comprising a first layer and a second layer coupled together, the first layer being coextensive with the second layer, the wrap having a casing portion in which the first layer and the second layer surround an interior space, the wrap having a first tab portion and a second tab portion positioned opposite each other across the casing portion, the first layer being coupled to the second layer in the first tab portion and the second tab portion of the wrap, the first and second layers comprising a flexible fabric material wherein the wrap is configured to be curved into a use position to surround a portion of the body of the user where a bed sore is located, each of the first layer and the second layer having a continuous planar exterior surface wherein one of the first layer and the second layer is configured to be in direct physical contact with the portion of the body of the user where the bed sore is located, the flexible fabric material being absorbent such that the flexible fabric material is configured to absorb body fluid of the user;
a support member coupled to the wrap and positioned in the interior space of the casing portion, the support member comprising a plurality of enclosed capsules, each enclosed capsule of the plurality of enclosed capsules surrounding a volume of gas, the volumes of gas of the plurality of capsules being separated from each other, the plurality of enclosed capsules being arranged in an array, the array comprising a plurality of rows of enclosed capsules, the plurality of rows being aligned parallel to each other, the enclosed capsules of adjacent rows of the plurality of rows being offset from each other along their respective rows; and
a connector coupled to the wrap, the connector having a first mating member positioned on the continuous planar exterior surface of the first layer on the first tab portion of the wrap, the connector having a second mating member positioned on the continuous planar exterior surface of the second layer on the second tab portion of the wrap, the first mating member being releasably couplable to the second mating member to secure the wrap in the use position, the connector comprising a hook-and-loop fastener.
